(19) United States
(12) Patent Application Publication
(10) Pub. No.: US 2002/0181048 A1
(43) Pub. Date: Dec. 5, 2002

(54) Method and system for high channel capacity wave division multiplexer and de-multiplexer using reflective and transmission holographic methodologies for optical communications and the like

(76) Inventors: Jacob L. Kuykendall JR., Sudbury, MA (US); John Donoghue, South Boston, MA (US)

Correspondence Address: McDermott, Will & Emery, 28 State Street, Boston, MA, 02109, US

(21) Appl. No.: 09/952,838

(22) Filed: Sep. 14, 2001

Related U.S. Application Data
(60) Provisional application No. 60/232,309, filed on Sep. 14, 2000.
(60) Provisional application No. 60/232,550, filed on Sep. 14, 2000.
(60) Provisional application No. 60/232,254, filed on Sep. 14, 2000.
(60) Provisional application No. 60/232,307, filed on Sep. 14, 2000.

(51) Int. Cl. H04J 14/02

(52) U.S. Cl. 359/130; 359/124

(57) ABSTRACT

A method for combining and separating multiple optical channels in a highly efficient manner includes multiplexing and de-multiplexing a large number of optical communications channels onto a transmission media, either fiber based or over-the-air. The holographic recording medium used for this invention has a spectral bandwidth of between approximately 488 nm and 2000 nm, and the actual channel limitations will be imposed by the limitations of the transmission media or the optical network components, such as the Erbium Doped Fiber Amplifiers and the attenuation windows of the fiber itself. With the present invention, the number of channels that can be attained over a fiber facility is typically 10,000, with 0.03 nm channel spacing. The theoretical and achievable number of over-the-air channels with this invention will be approximately 300,000 at a channel width of three Ghz per channel. Over-the-air applications could be an in-building high data rate local area networks or out-door short distance high data rate links between buildings.

### CROSS REFERENCES TO RELATED APPLICATIONS

This application claims the benefit of priority from commonly owned U.S. Provisional Patent Application Serial No. 60/232,309, filed Sep. 14, 2000; U.S. Provisional Patent Application Serial No. 60/232,550 filed Sep. 14, 2000; U.S. Provisional Patent Application Serial No. 60/232,254 filed Sep. 14, 2000; and U.S. Provisional Patent Application Serial No. 60/232,307, filed Sep. 14, 2000.

### FIELD OF THE INVENTION

The present invention relates to fiber optic networks, over-the-air laser communications networks and more particularity to super dense wave division multiplexing.

### BACKGROUND OF THE INVENTION

There currently exists several basic technologies that are used for producing dense wave division multiplexing (DWDM) filters. They include thin-film dielectric (interference) filters, planar array wave-guides, fiber Bragg gratings, fused-cascaded Mach-Zehnder interferometers, diffraction gratings and multi-stage cascading using splitter technology for channel separation. The technology currently employed to produce DWDM filters uses semi-conductor processor and micro machining techniques that require major plant investment and highly skilled personnel to manufacture the parts, assemble the subsystems and complete the testing.

Thin-film dielectric devices are the most broadly deployed filters for low channel-count DWDM systems in the 400 to 200 GHz channel spacing range. In order to provide such performance, 200 or more layers of material are deposited in a carefully controlled manner on a glass substrate in large deposition chambers. This mature technology offers good temperature stability, channel-to-channel isolation and a broad passband. The lower limit for channel spacing for this technology is 100 Ghz and channel count is in the range of 16 to 32 channels per fiber.

Planar array waveguides consist of a few layers of glass deposited on a silica or silicon substrate. The composition of the glass must be carefully controlled to present the correct index of refraction to the incident light. These layers are patterned and etched using variants of standard semiconductor process techniques, photolithography and reactive ion etching. Channel spacing is typically 100 Ghz, although 50 Ghz devices are available. Temperature stability is an issue, requiring active heating to bring the devices above ambient temperature. Due to the semi-conductor equipment manufacturing process necessary, there is a high capital equipment cost for this method.

Fiber-based devices are typified by long or short period Bragg gratings or interferometric structures, such as Mach-Zehnder configurations. These devices, particularly the latter, perform better at narrower channel spacing and moderate channel counts (less than 16). Channel spacing as narrow as 2.5 Ghz (0.04nm) have been demonstrated, which theoretically allows 1600 channels in the C-band, however there are no products on the market that claim this level of channelization. Manufacturing these components is generally labor intensive.

Diffraction grating devices feature a finely ruled grating that scatters the incident beam. Each wavelength channel corresponds to a unique diffraction angle and can be collected by individual fibers. These devices will be large due to long focal lengths required. Smaller devices can be made using high-frequency diffraction gratings, but will have high insertion loss and polarization dependent performance. Environmental sensitivity of these devices can be a concern, requiring careful control of the packaging and alignment.

Splitter technology employing multi-stage cascading is an extension of the legacy splitting technology currently used for the delivery of optical channels for fiber-to-the-curb and fiber-to-the-home network designs. This technical approach is limited in the number of stages that can be cascaded by the inherent loss added by each splitting module. Current channel capacity for this technology is in the range of 16 channels to 32 channels.

Of the several current art technologies now used for the manufacture of DWDM systems, none have proven to be cost effective for large channel capacities designed to serve access networks, including metropolitan and fiber-to-the-end-user applications.

### SUMMARY OF THE INVENTION

One aspect of the invention includes an improved method for inserting and extracting optical channels within a wave division multiplexing system that will be at 0.03 nm channel spacing using reflective holographic extraction and insertion techniques.

The method may 1 further include refining and optimizing the an associated manufacturing process for the holographic recording material that will allow further narrowing the channel spacing to 0.01 nm or narrower.

Another aspect of the invention includes an improved method for manufacturing high channel count dense wave division multiplexing systems by using connectorless interfaces between the cascaded multiple stages.

Another aspect of the invention includes an improved method for constructing a high channel dense wave division de-multiplexing system by using connectorless interfaces between the cascaded multiple stages.

Another aspect of the invention includes an improved method for inserting beam splitting based feedback loop for purposes of locking frequencies of multiple laser sources from a central hub location.

Another aspect of the invention includes an improved method for extracting and inserting one or multiple channels onto a fiber facility for add and drop purposes.

Another aspect of the invention includes an improved method for creating ring based networks that serve as SONET like applications with over 1000 times more capacity than single channel, conventional OC-192/STM-64 SONET systems.

Another aspect of the invention includes an improved methed for inserting beam splitting based feedback loops for purposes of locking frequencies of multiple laser sources that are remotely located.

Another aspect of the invention includes an improved method for extracting signals from a cascaded multi-stage SDWDM system for purposes of monitoring system performance.

According to another aspect of the invention, a holographic beam combining system includes:

a plurality of laser sources;

a holographic substrate having opposing first and second surfaces and a body defined by the first and second surfaces; and

a beam splitting device disposed on the first surface;

wherein the plurality of laser sources are configured to direct respective laser beams through the first surface of the holographic substrate to a point in the body, at which the plurality of laser beams are combined to form a combined beam which is reflected by the body to the beam splitting device on the first surface; and

wherein a first portion of the combined beam is reflected by the beam splitting device through the body and out of the second surface and a second portion of the combined beam is reflected back to the point in the body.

The the first portion of the combined beam reflected by the beam splitting device may include a greater portion of the combined beam than the second portion of the combined beam reflected by the beam splitting device. The first portion of the combined beam reflected by the beam splitting device may include approximately 95% of the combined beam and the second portion of the combined beam reflected by the beam splitting device comprises approximately 5% of the combined beam. The second portion of the combined beam may be reflected from the point back to the plurality of laser sources. Each of the plurality of laser sources may emit a laser beam at a different wavelength to the point in the holographic substrate body. Upon the second portion of the combined beam impinging the point in the holographic substrate body, each laser beam of a particular wavelength associated with a particular laser source may be reflected from the point to the laser source from which it emanated. The system may further include a feedback device associated with each of the laser sources, each the feedback device receiving the associated reflected laser beam. Each feedback device may adjust the laser beam emitted from each associated laser source. The system may include a plurality of holographic subtrates, each receiving a plurality of laser beams from a plurality of laser sources and outputting a respective first portion of a combined beam associated with each holographic substrate. The system may further include a further holographic substrate which receives the respective first portions of the combined beam from each of the plurality of holographic substrates and outputs a further combined beam.

According to another aspect of the invention, a holographic beam demultiplexing system inlcudes:

a holographic substrate having opposing first and second surfaces and a body defined by the first and second surfaces; and

a beam splitting device disposed on the first surface;

wherein the holographic substrate receives a combined laser beam comprising a plurality of laser beams, each having a different wavelength, through the second surface, the combined laser beam being reflected from the first surface of the holographic substrate by the beam splitting device to a point within the body; and

wherein the combined beam, upon impinging the point within the body, is split into each of the plurality of different wavelength laser beams and reflected out of the body through the first surface.

The system may further include a plurality of further holographic substrates, each recieving one of the plurality of different wavelength laser beams and splitting each of the plurality of different wavelength laser beams into a further plurality of of different wavelength laser beams.

According to another aspect of the invention, a method of combining a plurality of laser beams, each having a different wavelength component, into a combined laser beam includes:

A. directing the plurality of laser beams at a point within a holographic substrate, the a holographic substrate having opposing first and second surfaces and a body defined by the first and second surfaces;

B. combining the plurality of laser beams into a combined laser beam;

C. reflecting the combined laser beam from the point within the holographic substrate to a beam splitting device disposed on the first surface of the holographic substrate;

D. reflecting a first portion of the combined laser beam from the beam splitting device through the body and out of the second surface; and

E. reflecting a second portion of the combined beam back to the point in the body.

The first portion of the combined beam reflected by the beam splitting device may include a greater portion of the combined beam than the second portion of the combined beam reflected by the beam splitting device. The first portion of the combined beam reflected by the beam splitting device may include approximately 95% of the combined beam and the second portion of the combined beam reflected by the beam splitting device comprises approximately 5% of the combined beam. The method may further include reflecting the second portion of the combined beam from the point back to the plurality of laser sources.

According to yet another aspect of the invention, a method of demultiplexing a plurality of laser beams, each having a different wavelength component, includes:

A. directing a combined beam of the plurality of laser beams to a holographic substrate having opposing first and second surfaces and a body defined by the first and second surfaces, the combined leaser beam being directed into the holographic substrate through the second surface;

B. reflecting the combined beam at the first surface to a point within the body of the holographic substrate;

C. splitting the combined laser beam into the plurality of laser beams at the point; and

D. reflecting the plurality of laser beams from the body through the first surface of the body.

### BRIEF DESCRIPTION OF THE DRAWINGS

The invention is pointed out with particularity in the claims forming the concluding portion of the specification. The invention, both as to its organization and manner of operation, may be further understood by reference to the following description taking in connection with the following drawings:

FIG. 1 is a schematic illustration of prior art simplified optical network using cascaded bandwidth splitters;

FIG. 2 is a schematic illustration of prior art add/drop and dense wave division multiplexing system in accordance with the present invention;

FIG. 3 is a schematic illustration of the geometry for writing two holograms in accordance with the present invention;

FIG. 4 is a schematic illustration of the geometry for reading two holograms in accordance with the present invention,

FIG. 5 is a schematic illustration of a holographic beam combiner (HBC) configured to operate in the reflection mode for increased bandwidth in accordance with the present invention;

FIG. 6 is a schematic illustration of a first stage of a cascaded three stage multiplexer using a reflective mode HBC for the first stage and transmission hologram beam combiners for the second and third stages in accordance with the present invention;

FIG. 7 is a schematic illustration of a the embodiment of an embedded feed back loop using a retroreflective bandsplitter returning 5% of each of the multiplexed signals to the respecetive laser sources for purposes of locking their frequencies in accordance with the present invention;

FIG. 8 is a schematic illustration of a three stage cascaded multiplexer using a reflective mode HBC for the first stage and transmission mode HBCs for the second the third stages in accordance with the present invention;

FIG. 9 is a schematic illustration of a three stage cascaded de-multiplexer using a reflective mode HBC for the first stage and transmission mode HBCs for the second the third stages in accordance with the present invention; and

FIG. 10 is a schematic illustration of a three stage cascaded add and drop node in an embodiment that allows extracting or inserting any one or any randomly assigned group of the channels carried on the fiber transmission facility in accordance with the present invention.

### DESCRIPTION OF THE PREFERRED EMBODIMENTS

The present invention is discussed in the context of a high capacity, dense wave division multiplex/de-multiplexing system, herein referred to as super dense wave division multiplexing system (SDWDM), since it provides substantial improvement over current art systems both in channel capacity and in production costs. The holographic beam combiner (HBC), disclosed in co-pending U.S. patent application Ser. No. 60/232,550 filed on Sep. 14, 2000 entitled “Method and System for Combining Multiple Low Power Laser Sources to Achieve High Efficiency, High Power Outputs using Transmission Holographic Metholologies” is related to the present invention.

The basic idea of the HBC is to write multiple holograms onto a single volume of a recording material, with each hologram using a reference beam incident at a different angle, but keeping the object beam at a fixedangle. When illuminated by a single read beam at an angle matching one of the reference beams, a diffracted beam is produced in the fixed direction of the object beam. When multiple read beams, matching the multiple reference beams are used simultaneously, all the beams can be made to diffract in the same direction, under certain conditions that depend on the degree of mutual coherence between the input beams. Theoretically, both mutually coherent and mutually incoherent beams can be combined, with diffraction efficiencies approaching 100% for each beam individually. In practice, material constraints will reduce the diffraction efficencies to less than 100%, however with superior fabrication methodologies, efficiencies in excess of 90% have been attained.

The present invention utilizes HBC technology that uses a Bragg grating technique that allows extremely narrow channel spacing in the range of 0.03 nm, and extremely low insertion loss. It should be noted that 0.03 nm is not a technical lower limit, since narrower spacing can be achieved by increasing the thickness of holographic recording plate and using reflective holographic methodologies. By configuring the mux/de-mux modules into a classic multi-stage cascading arrangement, the present invention can be configured to separate 10,000 or more channels with 0.03 nm spacing between channels within a bandwidth of 300 nm. The usable bandwidth of the photopolymer material used as the recording medium has a range of between 488nm and 2000 nm, thus will operate across the L, C and S bands currently used for fiber communications as well as other areas of the spectrum outside of these bands. With the current development and implementation of Raman amplifiers that operate over the entire fiber spectrum, as opposed to spectrum limiting EDFA's, that operate only in the C and L bands, this invention will allow expanding the current communications bands used on fiber to the entire 488 to 2000 nm range. For example, with the present invention, 10,000 channels with a bandwidth of 3.75 GHz each can be derived using the spectrum between 1450 and 1750 when using Raman amplifiers only. For over-the-air optical embodiments of this invention, optical transmission systems can be built to accommodate hundreds of thousands of multi-gigabit channels, since there will not, in general, be the windows of attenuation that are inherent in fiber.

Briefly stated, in accordance with the present invention, optical signals containing a plurality of optical channels are combined and separated for purposes of sharing a fiber or over-the-air laser communications facility. The present invention uses holographic methodologies to achieve channel spacing on the order of 0.03 nm, thus significantly increasing the number of channels over current art. Though channel spacing and channel count figures used in describing this invention are given as 0.03 nm, this figure is not the smallest spacing achievable. By using thick (3 to 5 cm) holographic plates, extraordinary techniques for producing optically pure recording medium and using reflective hologram writing techniques, channel spacing of 0.01 nm or less can be achieved with corresponding channel widths of 1.25 GHz or less.

The present invention utilizes a combination of transmission and reflection holograms in a classic cascaded arrangement, to reach channel counts in the range of 10,000, by using 0.03 nm spacing (3.75 GHz) at the first stage combining 25 signal; 0.75nm spacing (93.75 GHz) at the second stage combining 20 first stage combiners; and 15 nm spacing (1.875 THz) at the third stage combining 20 second stage combiners. The bandwidth at the single fiber entry/exit side of the third stage will have 300 nm spacing (37.5 THz) and typically occupy the spectrum from 1450 nm to 1750 nm, thus extending the current wavelength window of opportunity. To avoid the channel limitations of EDFA amplifiers, Raman amplifiers only will be utilized for this embodiment. This configuration is scalable, both by the number of cascaded stages that are implemented and the number of channels of each stage. Bandwidth is also controllable, by selecting the thickness of the substrate and the laser sources that are utilized. The holograms that are written to create channel separation and wavelength designation are bi-directional, thus the same holograms can be utilized for multiplexing as are used for de-multiplexing. Taking advantage of this fact, during manufacturing, volume production will be accomplished by using large size substrates, writing holograms on the large sheets, and cutting them into appropriate sizes to make numerous pairs of holograms that will posess identical patterns, for use as mux/de-mux matched sets.

As the cost of fiber connectors is a major protion of cost fpr producing DWDM systems, as well as a contributor to the insertion loss within the unit, packaging designs utilize fiberless connections between the the cascaded holographic modules. By using anti reflection treatment and refraction index matching of the material used to produce the SDWDM, an embodiment can be connectorless interfaces between the cascaded DWDM modules. The geometry (entry and exit points) of the paths of light traveling within the multi-stage DWDM modules will be determined in the design and writing of the holograms, in each of the multiple stages. At the single fiber entry/exit side of the SDWDM will be a pigtail connector. At the third stage where high channel count fibers exit the SDWDM, a fiber pigtail connecter per channel will be attached. Conventional methods now used for attaching fiber to optical networking components will be utilized.

Locking the laser beams to avoid drifting is essential to the operation of a DWDM. The instertion of a reflective beamsplitter, disclosed in the Application for Patent cited above (U.S. patent application Ser. No. 60/232,550), provides an effective means of optically locking a large number of laser sources that are being combined through a holographic beam combiner. The present invention builds on the basic laser source locking concept, through the implementation of an optical feedback embodiment that is applied to the surface of the reflective stage modules of a cascaded multi-stage DWDM system, between the second and third stages. By applying a 1 to 8% retro-reflective surface on the combined beam exit side of the third stage holographic module, a return feedback signal is generated for each of the laser sources, thus locking each of them to a frequency that is determined by the characteristics of the laser source and the geometry of the holographic substrate. As the geometry of the substrate will be stable, particularity if it is housed in a controlled environment, the laser source will be locked to the natural frequency of the lumped and distributed elements of the path between the laser source and the reflective surface. Similarily, all laser sources that are feeding signals into the common reflective surface will be frequency locked to their respective lumped and distributed elements, and will only change if the parameters of the loop change. If there is a change, due for example to temperature shifts, the shift will be in unison effecting all of the laser sources and the channel separation and bandwidth will be maintained in their relative positions.

The present invention's method for multiplexing and de-multiplexing optical signals to and from a fiber based transmission facility can also be applied to extracting one optical channel, or groups of optical channels that can be adjacent or randomly located. If the fiber network is configured in a ring archicture, and each node that is connected to the fiber ring is equipped with a drop and insert module, by the channel assignments made for the node through selectively writing the holograms, the node can then be configured drop and insert any of the channels that are carried by the fiber. This can be done either as a single stage module or as a multi stage configration, similar to the three stage DWDM described above.

An embodiment of the present invention allows constructing SONET type networks that are all-optic and have a capacity of typically 10,000-3.75 GHz channels, as desribed above, or other variations will different channel counts and bandwidths. Further, the bandwidths need not be all of the same width or spacing. The bandwidth avilable through this system is several thousand times the bandwidth of a traditional SONET system, and the production cost is a small fraction of a SONET system. For ring based networks that may have distributed laser sources, system wide frequency locking can be accomplished by selecting one common channel to serve as the master frequency channel and pass that one signal through each of the distributed feedback mirrors in the ring.

System-wide signal monitoring can be accomplished by directing a poriton of the laser feed back energy used for frequency locking to a network monitoring facility that will consolodate all of the laser source information. In so doing, all laser sources will be dynamically monitored for degradation and failure. Similarily, on the return path, a small portion of the concentrated signal can be redirected and analyzed to determine the quality of each of the return channels contained within the composite beam. By monitoring the outgoing composite signal and the incoming composit signal from this location, from the two single beam entry and exit locations, the health of the entire transmission facility can be observed from one focal point.

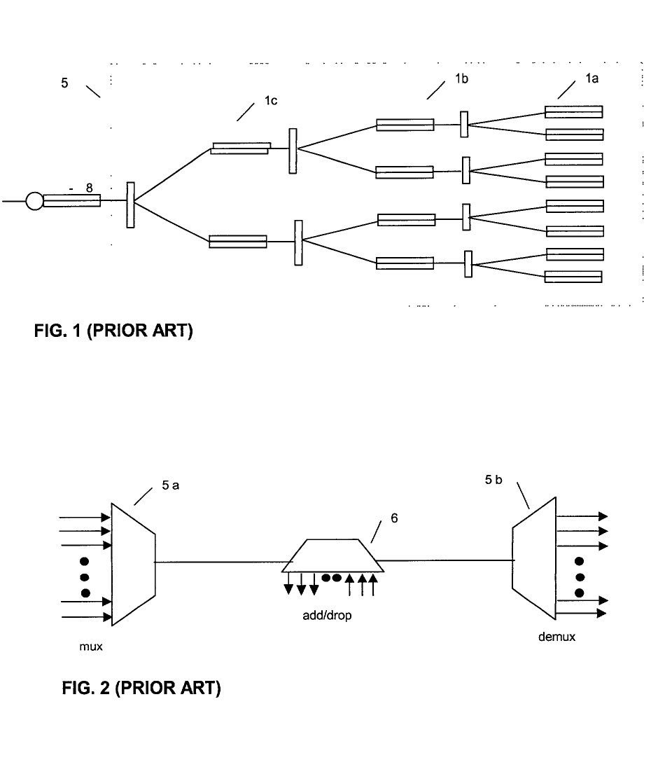

FIG. 1 depicts a prior art WDM 5 that handles 8 optical channels, through band splitting methodologies. This configuration is for a three stage cascaded design with each stage providing a 2 for 1 split of the wavelengths. The design of the multiplexer and the de-multiplexer are identical, as signals can be originated from either direction. The limitation of this design and methodology is in the limited number of channels that can be provided and the insertion loss introduced by each of the cascaded stages.

FIG. 2 depicts a prior art drop and insert arrangement with a mux 5a and demux 5b located at opposite ends of a fiber facility. In this arrangement, all channels are extracted and re-inserted at the add/drop 6 location, basically through a mux/demux system add/drop node terminated at that facility. Like the mux/demux facility described in FIG. 1 above, this arrangement and methodology is limited in the number of channels that can be delivered and has high insertion loss due to the inherent losses of splitter technology.

In order to fully understand the embodiments of this invention, it is necessary to describe the technique for separating channels for insertion and extraction onto a fiber facility. It should be noted that although this embodiment is for a fiber based transmission facility, the SDWDM described herein works for laser based over-the-air communications as well, without the inherent second and third order cross talk and attenuation windows that exist within the optical cable facilities.

The holographic beam combining modules that are the building blocks of this invention are described in a provisional patent (U.S. patent application Ser. No. 60/232,550) and the subsequent utility application for patent filed on Sep. 14, 2001, filed by one of the co-inventors listed on this utility applications.

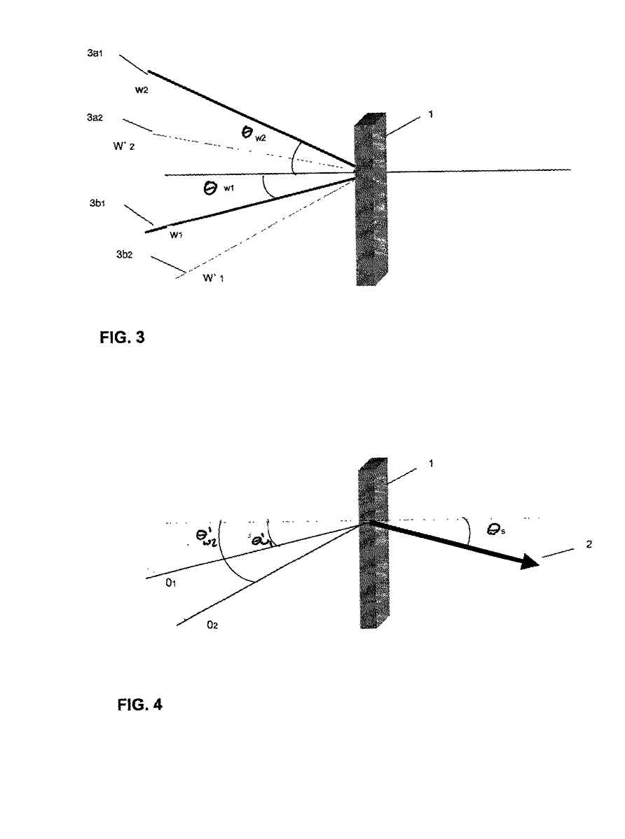

As point of reference, the process for writing transmission mode holograms is contained below and diagrammed in FIG. 3. and was also disclosed in co-pending U.S. Patent Application entitled “Method and System for Combining Multiple Low Power Laser Sources to Achieve High Efficiency, High Power Outputs using Transmission Holographic Metholologies” by one of the co-inventors of the present invention. (Ref. U.S. patent application Ser. No. 60/232,550 filed on Sep. 14, 2000). The subsequent Utility Patent Application has a filing date of Sep. 14, 2001.

To achieve channel spacing of 0.03 nm or smaller, reflective mode holograms written on thick (2 to 3 cm) substrates are used. The analysis and methodology for determining the angles for writing reflection mode holograms is the same as for transmission mode, however in the construction of reflective mode holograms the substrate is rotated by 90° from transmission holograms, thus creating gratings that are parallel to the face of the holographic substrate. The analysis for determining the angular information for writing transmission and reflection mode holograms will be the same as the process to determine the precise positioning of the laser beams, with exit and entrance beams angles, necessary to position holographic substrates for multi-stage cascaded SDWDM modules and to locate the fiber pigtails that will be used for interfacing to the SDWDM modules. This analysis disclosed in the above-mentioned Application for Patent is shown below, and will also be the basis for creating automated production tools, such as numerically controlled diflection mirrors for directing laser beams in the writing of multiple holograms on holographic substrates, and for determining the precision exit and entrance and angular position of fiber pigtails that will attatch to the holographic substrates.

In order to describe the writing of holograms for this application, reference is made to FIG. 3 that is a schematic of a geometry for writing 2 holograms at 532 nm, chosen for discussion purposes. The objective is to write an HBC that can combine two lasers that are each at a wavelength near 980 nm. The first step in this process is to choose a set of writing angles for the writing wavelength of 532 nm. A summary of the analysis is:

FIG. 3 shows the basic writing geometry. Consider first the process for writing the first hologram; using beams W₁ 3b₁ (reference) and W₂ 3a₁ (object), using laser beams of wavelength 532 nm. We choose these two beams to be symmetric with respect to the axis normal to the PDA substrate 1. If read by a laser beam at 532 nm, the read beam will diffract efficiently only if it is Bragg matched, i.e., incident at exactly the same angle as, for example, the object beam (W₂) 3a₁, and produce a diffracted beam on the other side parallel to the reference beam (W₁) 3b₁.

FIG. 4 shows the basic reading geometry. When read by a laser beam O₁ at 980 nm, as shown in FIG. 4, the Bragg incidence angle as well as the diffracted angle (θ_{S}) would be larger. Consider next the process for writing the second hologram, using a new pair of beams at 532 nm: W′₁ 3b₂ and W′₂ 3a₂, as shown in FIG. 3. The goal is to choose the directions for these two beams to be such that when this hologram is read by a laser beam O₂ at a wavelength of (980nm+Δλ), where Δλ is to be chosen by us, the diffracted beam will come out at the same angle θ_{S}.

In designing these angles, the first step is to choose a value of the common diffraction angle, θ_{S}, fix the writing wavelength to be 532 nm, and choose the wavelength for the first read beam, O₁, to be exactly 980 nm (i.e., Δλ₁=0). This determines the first pair of writing angles, θ_{W1} and θ_{W2}. We then choose the value of δ, the angular distance between the first and the second read beams, as well as the wavelength of the second read beam, O₂. These constraints yield a new pair of writing angles, θ′_{W1} and θ′_{W2}, for the beams W′₁ 3b₂ and W′₂ 3a₂, respectively, in FIG. 3. Explicit analysis shows that these angles are given by:

$$[ {θ}_{W1} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] - \tilde{δ} / 2 \} ] ] \\ [ {θ}_{W2} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] + \tilde{δ} / 2 \} ] ]$$

where we have defined:

$$[ {\tilde{θ}}_{S} = {Sin}^{- 1} ( \frac{Sin {θ}_{S}}{{n}_{R}} ) ] \\ [ \tilde{δ} = {Sin}^{- 1} ( \frac{Sin ( {θ}_{S} + δ )}{{n}_{R}} ) - {Sin}^{- 1} ( \frac{Sin {θ}_{S}}{{n}_{R}} ) ]$$

wherein δ≡(Re ad Angle at λ_{W})−(Re ad Angle at a predetermined wave length λ_{O})

n_{W}≡index at the writing wavelength

n_{R}≡index at the reading wavelength

λ_{W}≡the writing wavelength

λ_{R}≡the reading wavelength

These equations are used as follows:

STEP 1: Choose a fixed value for θ_{S} (e.g., π/3)

STEP 2: Choose a fixed value for λ_{W} (e.g., 532 nm)

STEP 3: Determine the symmetric pair of writing angles, θ_{W1} and θ_{W2}, which correspond to the case of λ_{R}=980 nm, and δ=0

STEP 4: Choose a new value of δ (e.g., 50 mrad) and a new value of λ_{R} (e.g. 981 nm), which yield a new pair of writing angles

STEP 5: Repeat step 4 for every new pair of writing angles necessary

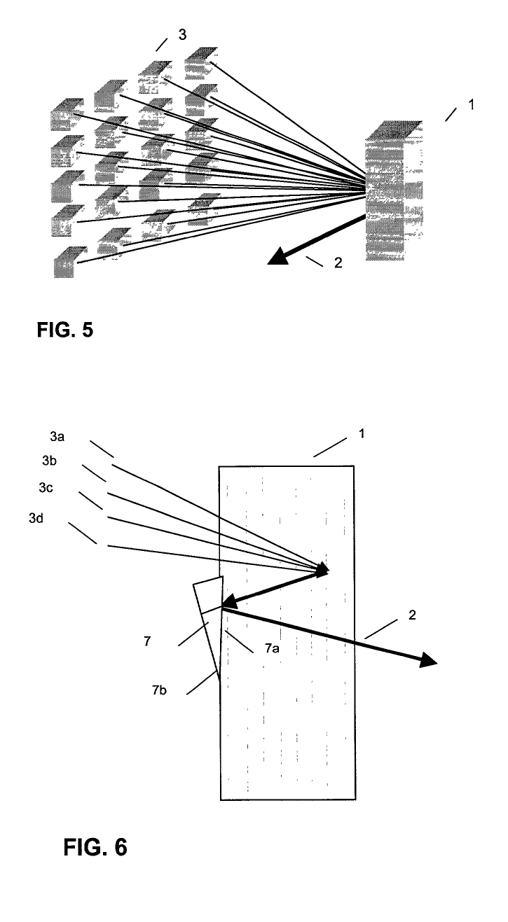

It should be noted that these equations take into account the effect of holographic magnification when the read wavelength is longer than the writing wavelength, and the effect of potentially different indices of refraction at the read and write wavelengths. FIG. 5 depicts a reflection mode HBC 1 that is configured to accept 25 λs 3 showing a single combined output beam 2, showing the arrangement of a reflective hologram.

FIG. 6 depicts a reflective mode HBC 1 that is configured to exit the concentrated beam out the opposite side of the holographic substrate via band splitter 7 that both reflects the combined beam 2 through the hologram substrate 1 and reflects a portion of the signal back to the laser sources 3a-3d. The combined output signal 2 is directed through the holographic substrate 1 for purposes of combining multiple cascaded HBC elements within a compact package.

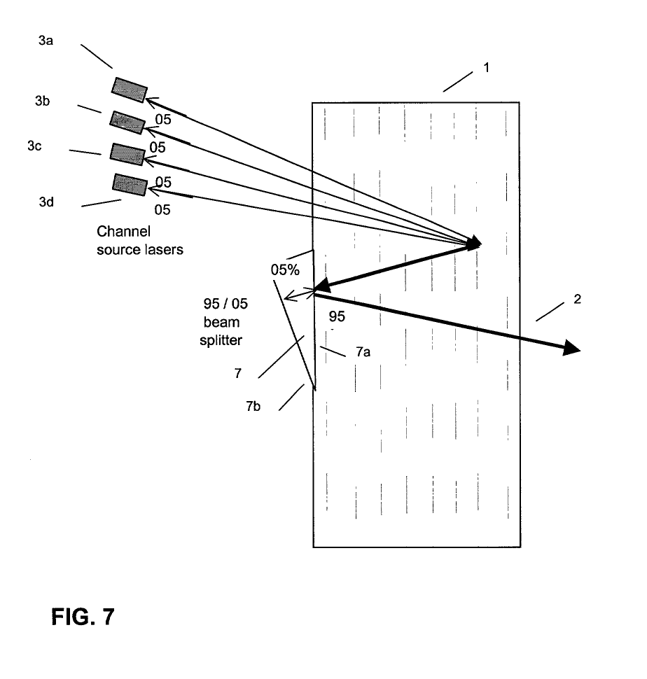

FIG. 7 depicts the arrangement for returning a feedback signal back to the laser sources in order to lock them to a natural frequency. The wedged shaped beam splitter 7 serves two functions, a) to direct 95% of the laser beam power through the holographic substrate 1 and b) to direct 5% of the laser power back to each of the laser sources to lock their frequencies. This is accomplished by having the face 7a of the beam splitter 7 touching the holographic substrate be a 95% band splitter with one way characteristics and the outside face 7b of the wedge beam splitter 7 that is perpendicular to the beam 2 be a mirror. With this arrangement, 5% of the power from each of the lasers, each of a different wavelength, will pass through the 95% beam splitter, strike the mirror and retro-reflect back to the laser that originated the signal. A feed back loop is then established for each of the lasers, made up of the natural frequency of the laser and the optical characteristics of the path between the common mirror and each laser. With this arrangement, conditions such as temperature fluctuations or aging related conditions that result in geometric changes between the feed back band splitter 7 and the laser sources 3a-3d, the same changes will occur for all lasers that are locked and if drifting does occur, all lasers will drift in unison, thus maintaining channel separation.

The 5% feedback signal that is extracted with the 95% beam splitter face 7a can also be used as the signal source for monitoring the status of the laser sources. To accomplish this, the 5% signal can be further split at the wedge shaped dual mirror face 7b, and directed to a channel monitor facility that monitors all channels, and alarms upon sensing signal degradation. The same monitoring point can be used when the facility is used in the de-multiplexing mode, where feedback to the laser sources is not needed. If HBC modules are manufactured to serve both mux and de-mux applications, the incoming 5% signal will appear on an exit point of the wedged shaped band splitter 7 and can be used to monitor the health of channels being received from remote locations. With this arrangement, every channel that originates and is received through the high-count channel stages of the system can be captured at one location for monitoring.

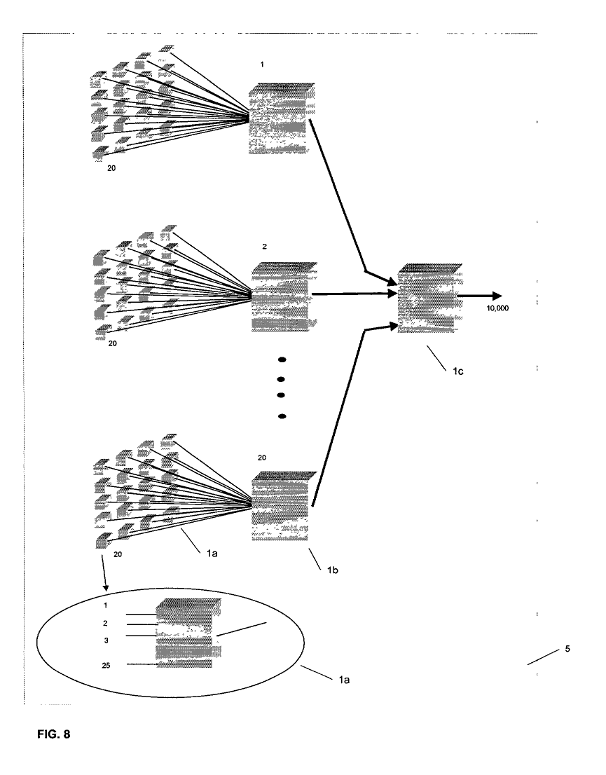

FIG. 8 depicts a cascaded three stage multiplexing system 5 made up of HBC modules 1a, 1b, 1c that progressively combine wavelengths and groups of wavelengths, to reach a very large number, typically 10,000 for this example. In this case, the channels that are combined in the first stage 1b have a bandwidth of 2 GHz and a channel spacing of 0.016 nm, (used for purposes of this analysis) accomplished with the reflection holographic methodology described above. The spectrum required to obtain this number of channels is 160 nm, well within the L, C and S bands now utilized for communications on fiber. As the configuration shown in FIG. 7 is bi-directional, the same HBC elements would be used for the de-multiplexer.

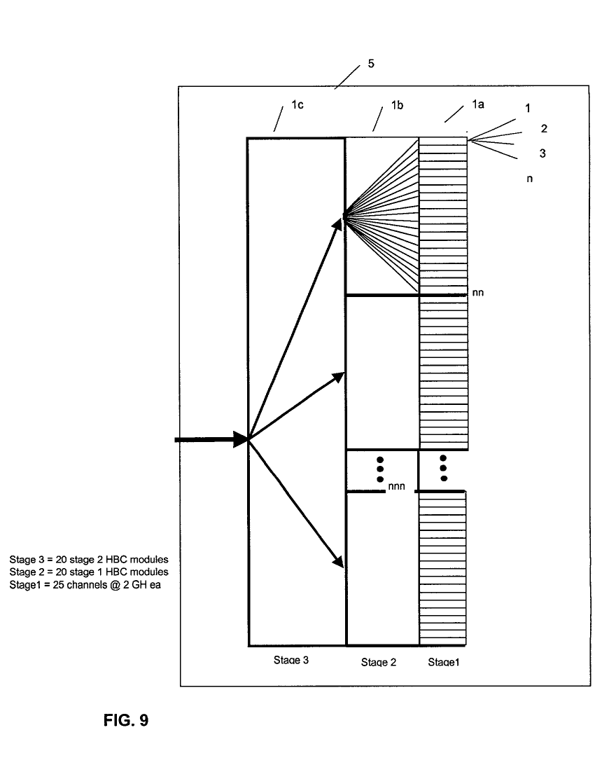

FIG. 9 is a schematic illustration of a demultiplexer 5 of typically 10,000 channels, each of 2 GHz bandwidth. The multiplexer and de-multiplexer packages may be identical.

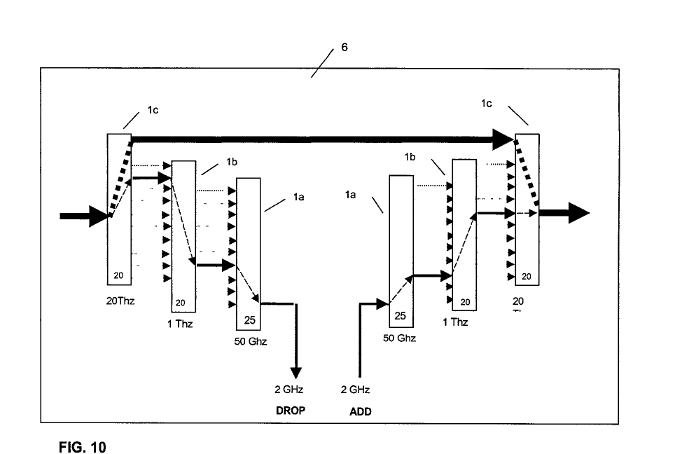

FIG. 10 is a drop and add nodal design 6 that is configured to extract any one or group of channels from a fiber facility. Though the HBC can be constructed to extract or insert a single or any number of channels onto a fiber in a single stage, this configuration is shown to demonstrate the extreme flexibility that this invention has. This configuration utilized a channel bandwidth of 2 GHz, with the same 10,000-channel configuration used in the examples above. For this facility, the backbone bandwidth is 20 THz at stage 1c, and the pass bandwidth at each of the drop stages 1b is 1 THz, 50 GHz at stage 1a and 2 GHz for each channel.

The reflective holographic super dense wave multiplexer has low insertion loss as determined by the optical purity of the holographic material. This is measured as transmission efficiency, which can exceed 95%. Increasing the number of input channels does not increase the per channel loss, unlike current technology multiplexing products. With low insertion loss, the SDWDM units may be cascaded to achieve large channel configurations, either at a single location or in a distributed fashion. Low insertion loss enables constructing passive all-optic networks for local loop and metropolitan applications, as well as for conventional long distance applications. The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. An improved method for inserting and extracting optical channels within a wave division multiplexing system that will be at 0.03 nm channel spacing using reflective holographic extraction and insertion techniques.

2. The method of claim 1 further including refining and optimizing the an associated manufacturing process for the holographic recording material that will allow further narrowing the channel spacing to 0.01 nm or narrower.

3. An improved method for manufacturing high channel count dense wave division multiplexing systems by using connectorless interfaces between the cascaded multiple stages.

4. An improved method for constructing a high channel dense wave division de-multiplexing system by using connectorless interfaces between the cascaded multiple stages.

5. An improved method for inserting beam splitting based feedback loop for purposes of locking frequencies of multiple laser sources from a central hub location.

6. An improved mentod for extracting and inserting one or multiple channels onto a fiber facility for add and drop purposes.

7. An improved method for creating ring based networks that serve as SONET like applications with over 1000 times more capacity than single channel, conventional OC-192/STM-64 SONET systems.

8. An improved methed for inserting beam splitting based feedback loops for purposes of locking frequencies of multiple laser sources that are remotely located.

9. An improved method for extracting signals from a cascaded multi-stage SDWDM system for purposes of monitoring system performance.

10. A holographic beam combining system comprising:
a plurality of laser sources;
a holographic substrate having opposing first and second surfaces and a body defined by said first and second surfaces; and
a beam splitting device disposed on said first surface;
wherein said plurality of laser sources are configured to direct respective laser beams through said first surface of said holographic substrate to a point in said body, at which said plurality of laser beams are combined to form a combined beam which is reflected by said body to said beam splitting device on said first surface; and
wherein a first portion of said combined beam is reflected by said beam splitting device through said body and out of said second surface and a second portion of said combined beam is reflected back to said point in said body.

11. The system of claim 10 wherein said first portion of said combined beam reflected by said beam splitting device comprises a greater portion of said combined beam than said second portion of said combined beam reflected by said beam splitting device.

12. The system of claim 10 wherein said first portion of said combined beam reflected by said beam splitting device comprises approximately 95% of said combined beam and said second portion of said combined beam reflected by said beam splitting device comprises approximately 5% of said combined beam.

13. The system of claim 10 wherein said second portion of said combined beam is reflected from said point back to said plurality of laser sources.

14. The system of claim 13 wherein each of said plurality of laser sources emits a laser beam at a different wavelength to said point in said holographic substrate body.

15. The system of claim 14 wherein, upon said second portion of said combined beam impinging said point in said holographic substrate body, each laser beam of a particular wavelength associated with a particular laser source is reflected from said point to the laser source from which it emanated.

16. The system of claim 15, further comprising a feedback device associated with each of said laser sources, each said feedback device receiving said associated reflected laser beam.

17. The system of claim 16 wherein each feedback device adjusts said laser beam emitted from each associated laser source.

18. The system of claim 10 comprising a plurality of holographic subtrates, each receiving a plurality of laser beams from a plurality of laser sources and outputting a respective first portion of a combined beam associated with each holographic substrate.

19. The system of claim 18 further comprising a further holographic substrate which receives said respective first portions of said combined beam from each of said plurality of holographic substrates and outputs a further combined beam.

20. A holographic beam demultiplexing system comprising:
a holographic substrate having opposing first and second surfaces and a body defined by said first and second surfaces; and
a beam splitting device disposed on said first surface;
wherein said holographic substrate receives a combined laser beam comprising a plurality of laser beams, each having a different wavelength, through said second surface, said combined laser beam being reflected from said first surface of said holographic substrate by said beam splitting device to a point within said body; and
wherein said combined beam, upon impinging said point within said body, is split into each of said plurality of different wavelength laser beams and reflected out of said body through said first surface.

21. The system of claim 20 further comprising a plurality of further holographic substrates, each recieving one of said plurality of different wavelength laser beams and splitting each of said plurality of different wavelength laser beams into a further plurality of of different wavelength laser beams.

22. A method of combining a plurality of laser beams, each having a different wavelength component, into a combined laser beam comprising:
A. directing said plurality of laser beams at a point within a holographic substrate, said a holographic substrate having opposing first and second surfaces and a body defined by said first and second surfaces;
B. combining said plurality of laser beams into a combined laser beam;
C. reflecting said combined laser beam from said point within said holographic substrate to a beam splitting device disposed on said first surface of said holographic substrate;
D. reflecting a first portion of said combined laser beam from said beam splitting device through said body and out of said second surface; and
E. reflecting a second portion of said combined beam back to said point in said body.

23. The method of claim 22 wherein said first portion of said combined beam reflected by said beam splitting device comprises a greater portion of said combined beam than said second portion of said combined beam reflected by said beam splitting device.

24. The method of claim 22 wherein said first portion of said combined beam reflected by said beam splitting device comprises approximately 95% of said combined beam and said second portion of said combined beam reflected by said beam splitting device comprises approximately 5% of said combined beam.

25. The system of claim 22 further comprising reflecting said second portion of said combined beam from said point back to said plurality of laser sources.

26. A method of demultiplexing a plurality of laser beams, each having a different wavelength component, comprising:
A. directing a combined beam of said plurality of laser beams to a holographic substrate having opposing first and second surfaces and a body defined by said first and second surfaces, said combined leaser beam being directed into said holographic substrate through said second surface;
B. reflecting said combined beam at said first surface to a point within said body of said holographic substrate;
C. splitting said combined laser beam into said plurality of laser beams at said point; and
D. reflecting said plurality of laser beams from said body through said first surface of said body.
